(19) United States
(12) Patent Application Publication
(10) Pub. No.: US 2013/0069919 A1
(43) Pub. Date: Mar. 21, 2013

(54) Display Devices Including a Chip That Overlaps Bypass Lines

(71) Applicants: Seong-Young Ryu, Seoul (KR); Hyunsang Park, Seongnam-si (KR); Woo-Nyoung Lee, Seocho-gu (KR)

(72) Inventors: Seong-Young Ryu, Seoul (KR); Hyunsang Park, Seongnam-si (KR); Woo-Nyoung Lee, Seocho-gu (KR)

(73) Assignee: Samsung Electronics Co., Ltd.

(21) Appl. No.: 13/609,870

(22) Filed: Sep. 11, 2012

(30) Foreign Application Priority Data
Sep. 15, 2011 (KR) 10-2011-0092839

(51) Int. Cl. G09G 5/00

(52) U.S. Cl. 345/204

(57) ABSTRACT

Display devices are provided. The display devices may include a source driver chip between a printed circuit board and a display panel. The source driver chip may overlap a plurality of bypass lines that are connected to the printed circuit board and the display panel.

### CROSS-REFERENCE TO RELATED APPLICATIONS

This U.S. non-provisional application claims priority under 35 U.S.C §119(a) of Korean Patent Application No. 10-2011-0092839, filed on Sep. 15, 2011, the disclosure of which is hereby incorporated by reference in its entirety.

### BACKGROUND

The present disclosure relates to display devices, and more particularly, to display devices including a chip that overlaps bypass lines.

Display devices (e.g., computer monitors, televisions (TVs), mobile display devices, etc.) may include display technologies such as Cathode Ray Tube (CRT), Field Emission Device (FED), Liquid Crystal Display (LCD), and Active Matrix Organic Light Emitting Diode (AMOLED) technologies, among others. Display devices have circuits for processing image signals and panels for displaying image signals. Increased resolution of images to be displayed on the display devices, however, increases the size/quantity of image signals to be processed. Moreover, the increased size/quantity of image signals to be processed may increase the amount of heat generated by the circuits that process the image signals.

### SUMMARY

A display device according to various embodiments may include a printed circuit board, a display panel, and a film connected between the printed circuit board and the display panel. The film may include a plurality of source driver units thereon. Each of the plurality of source driver units may include a source driver chip, a plurality of input lines connected between the source driver chip and the printed circuit board, a plurality of output lines connected between the source driver chip and the display panel, and a plurality of bypass lines electrically connected between the printed circuit board and the display panel. The source driver chip may overlap at least a portion of the plurality of bypass lines.

In various embodiments, the plurality of bypass lines may be protected from signal communications with the source driver chip, and may be configured to radiate heat from the source driver chip to the printed circuit board and the display panel.

According to various embodiments, the plurality of input lines may be connected between the printed circuit board and input pads that are on a first end of a lower surface of the source driver chip, and the plurality of output lines may be connected between the display panel and output pads that are on a second end of the lower surface of the source driver chip.

In various embodiments, the bypass lines may include a plurality of first bypass lines connected between the source driver chip and the printed circuit board. The bypass lines may also include a plurality of second bypass lines connected between the source driver chip and the display panel. The source driver chip may electrically connect the plurality of first bypass lines and the plurality of second bypass lines.

According to various embodiments, the plurality of first bypass lines may be connected between the printed circuit board and bypass pads that are on a first end of a lower surface of the source driver chip.

In various embodiments, the plurality of second bypass lines may be connected between the display panel and bypass pads that are on a second end of a lower surface of the source driver chip.

According to various embodiments, some of the bypass lines may connect with gates of pixels of the display panel.

In various embodiments, a plurality of pads may be on first and second opposing ends of a lower surface of the source driver chip, and the pads on the first end may be larger in size than the pads on the second end.

According to various embodiments, a plurality of pads may be on first and second opposing ends of a lower surface of the source driver chip, and the pads on the second end may be more numerous than the pads on the first end.

In various embodiments, the plurality of bypass lines may directly connect the printed circuit board and the display panel.

According to various embodiments, a plurality of pads may be on first and second opposing ends of a lower surface of the source driver chip, and the lower surface of the source driver chip may further include pad-less dummy regions on the plurality of bypass lines.

In various embodiments, the plurality of input lines and the plurality of output lines may form a straight line.

A multimedia device according to various embodiments may include a modem unit and a decoding unit configured to decode data input via the modem unit. The multimedia device may also include a display unit and a display control unit configured to control the display unit to display decoded data from the decoding unit. The multimedia device may further include a processing unit that is configured to control the modem unit, the decoding unit, the display unit, the display control unit, and a user interface unit. The display unit may include a display device that includes a film connected between a printed circuit board and a display panel. Also, a plurality of source driver units may be on the film. Each of the plurality of source driver units may include a source driver chip, a plurality of input lines connected between the source driver chip and the printed circuit board, a plurality of output lines connected between the source driver chip and the display panel, and a plurality of bypass lines electrically connected between the printed circuit board and the display panel, the source driver chip overlapping at least a portion of the bypass lines.

In various embodiments, the modem unit, the decoding unit, the display unit, the display control unit, the user interface unit, and the processing unit may be included in a television. Additionally, the plurality of bypass lines may be protected from signal communications with the source driver chip, and may be configured to radiate heat from the source driver chip to the printed circuit board and the display panel.

A display device according to various embodiments may include a printed circuit board, a display panel, and a source driver chip between the printed circuit board and the display panel. The display device may also include a plurality of conductive bypass lines extending between the printed circuit board and the display panel. The plurality of conductive bypass lines may overlap with at least a periphery of the source driver chip to conduct heat therefrom to the printed circuit board and/or the display panel.

In various embodiments, the display device may further include a plurality of input lines connected between the source driver chip and the printed circuit board. The display device may also include a plurality of output lines connected between the source driver chip and the display panel. Additionally, the plurality of bypass lines may extend in a direction that is substantially in parallel with at least one of the plurality of input lines and the plurality of output lines.

According to various embodiments, the source driver chip may extend in a direction that is substantially perpendicular to the direction in which the plurality of bypass lines extend, to overlap entire widths of the plurality of bypass lines.

In various embodiments, a width of the source driver chip along the perpendicular direction may be greater than combined widths of the plurality of bypass lines and either the plurality of input lines or the plurality of output lines along the perpendicular direction.

According to various embodiments, the plurality of bypass lines may contact the source driver chip via dummy pads.

In various embodiments, the plurality of bypass lines may include a plurality of first bypass lines connected to a first end of the source driver chip. The plurality of bypass lines may also include a plurality of second bypass lines connected to a second end of the source driver chip that is opposite the first end. Additionally, the first and second bypass lines may connect the printed circuit board and the display panel through the source driver chip.

### BRIEF DESCRIPTION OF THE FIGURES

The above and other features and advantages of the disclosure will become more apparent in view of the attached drawings and accompanying detailed description.

FIG. 1 is a block diagram schematically illustrating a display device, according to various embodiments of the inventive concept.

FIG. 2 is a diagram schematically illustrating a physical configuration of a display device, according to various embodiments.

FIG. 3 is a diagram schematically illustrating a film, according to various embodiments of the inventive concept.

FIG. 4 is a diagram schematically illustrating one of the source driver chips of FIG. 3, according to various embodiments.

FIGS. 5 and 6 are graphs illustrating a radiation effect of a source driver chip, according to various embodiments.

FIG. 7 is a diagram schematically illustrating a film, according to various embodiments of the inventive concept.

FIG. 8 is a diagram schematically illustrating one of the source driver chips of FIG. 7, according to various embodiments.

FIG. 9 is a diagram schematically illustrating a film, according to various embodiments of the inventive concept.

FIG. 10 is a diagram schematically illustrating one of the source driver chips of FIG. 9, according to various embodiments.

FIG. 11 is a diagram schematically illustrating an integrated circuit device, according to various embodiments of the inventive concept.

FIG. 12 is a diagram schematically illustrating an integrated circuit device, according to various embodiments of the inventive concept.

FIG. 13 is a block diagram schematically illustrating a multimedia device, according to various embodiments of the inventive concept.

FIGS. 14 to 17 are diagrams illustrating examples of a multimedia device, according to various embodiments of the inventive concept.

### DETAILED DESCRIPTION

Example embodiments are described below with reference to the accompanying drawings. Many different forms and embodiments are possible without deviating from the spirit and teachings of this disclosure and so the disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of layers and regions may be exaggerated for clarity. Like reference numbers refer to like elements throughout.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, integers, steps, operations, elements, and/or components, but do not preclude the presence or addition of one or more other features, integers, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

It will be understood that although the terms first, second, etc. may be used herein to describe various elements, these elements should not be limited by these terms. These terms are only used to distinguish one element from another. Thus, a first element could be termed a second element without departing from the teachings of the present embodiments.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein may be interpreted accordingly.

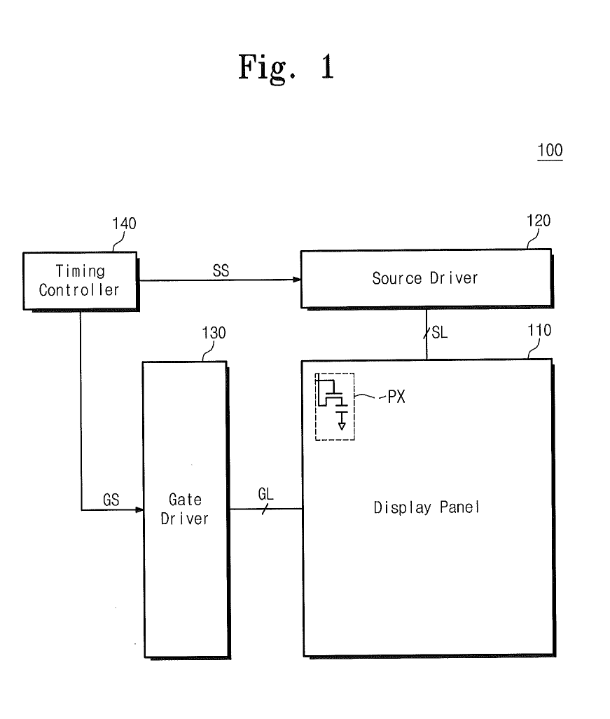

FIG. 1 is a block diagram schematically illustrating a display device according to various embodiments of the inventive concept. Referring to FIG. 1, a display device 100 includes a display panel 110, a source driver 120, a gate driver 130, and a timing controller 140.

The display panel 110 is connected with the source driver 120 via source lines SL and with the gate driver 130 via gate lines GL. The display panel 110 includes a plurality of sub pixels PX, each of which is connected with one of the source lines SL and one of the gate lines GL.

The source driver 120 receives a source signal SS from the timing controller 140. The source driver 120 outputs signals via the source lines SL in response to the source signal SS. The source signal SS may include an image signal and a control signal (e.g., an output start signal, a horizontal start signal, a polarity reverse signal (PRS), etc.).

The gate driver 130 outputs signals via the gate lines GL in response to a gate signal GS from the timing controller 140. The gate signal GS may include a start signal, a clock signal, etc.

The timing controller 140 is configured to output the source signal SS and the gate signal GS. For example, the timing controller 140 may output the source and gate signals SS and GS according to an image signal and a control signal input from an external device.

In various embodiments, the display device 100 may be a display device such as an LCD display device, an AMOLED display device, etc.

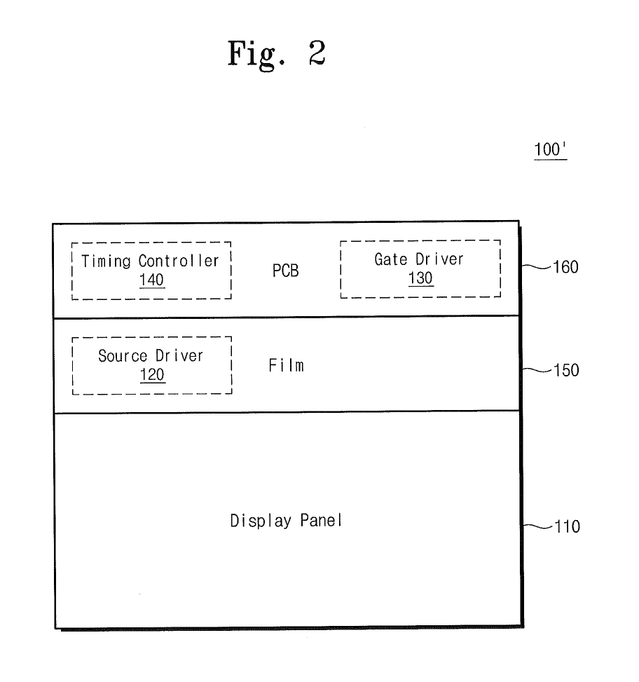

FIG. 2 is a diagram schematically illustrating a physical configuration of a display device. Referring to FIG. 2, a display device 100′ includes a display panel 110, a film 150, and a printed circuit board (PCB) 160. The film 150 is disposed between the display panel 110 and the PCB 160.

A source driver 120 is provided on the film 150. A gate driver 130 and a timing controller 140 are provided on the PCB 160. Wires (e.g., gate lines GL) for connecting the gate driver 130 and the display panel 110 may be provided on the film 150.

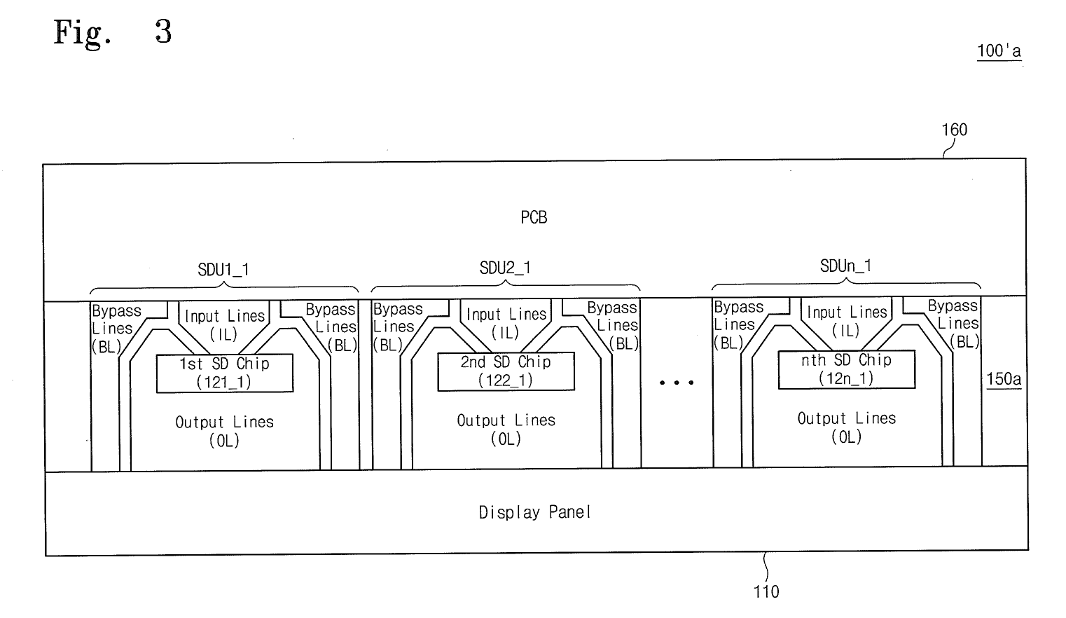

FIG. 3 is a diagram schematically illustrating a film according to various embodiments of the inventive concept. Referring to FIG. 3, a display device 100′a includes a plurality of source driver units SDU1_1 through SDUn_1 provided on a film 150a.

Each of the source driver units SDU1_1 through SDUn_1 includes a source driver chip, input lines IL, output lines OL, and bypass lines BL. For example, the source driver unit SDU1_1 includes a source driver chip 121_1, input lines IL, output lines OL, and bypass lines BL. In another example, the source driver unit SDUn_1 includes a source driver chip 12n_1, input lines IL, output lines OL, and bypass lines BL.

The source driver chips 121_1 through 12n_1 constitute the source driver 120. The input lines IL are connected with a PCB 160 and the source driver chips 121_1 through 12n_1. In various embodiments, a source signal SS may be transferred via the input lines IL. The output lines OL are connected with a display panel 110 and the source driver chips 121_1 through 12n_1. The output lines OL may be source lines SL.

The bypass lines BL are connected with the display panel 110 and the PCB 160. The bypass lines BL are provided at/on the film 150a, and are lines passing through without exchanging signals with the source driver chips 121_1 through 12n_1 as a constituent element of the film 150a. Some of the bypass lines BL may be gate lines GL for connecting a gate driver 130 and the display panel 110. For example, bypass lines BL of one of the source driver units SDU1_1 through SDUn_1 may be selected as gate lines GL. In particular, the bypass lines BL of the outermost source driver unit SDU1_1 or SDUn_1 may be selected as the gate lines GL.

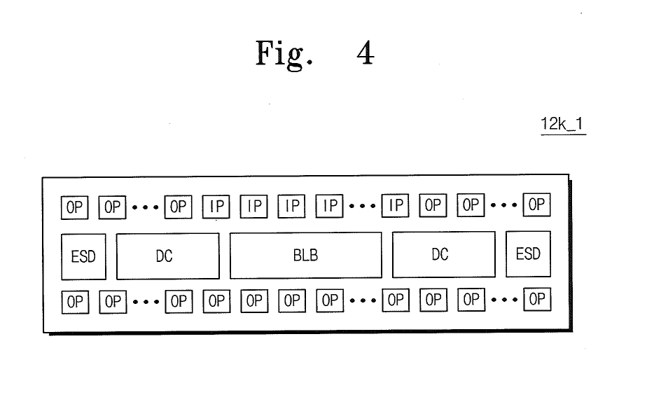

FIG. 4 is a diagram schematically illustrating a source driver chip 12k_1. The source driver chip 12k_1 (where k is one of 1 through n) may be one of the source driver chips illustrated in FIG. 3. In other words, one or more of the source driver chips 121_1 through 12n_1 in FIG. 3 may have the same structure as that illustrated in FIG. 4.

Referring to FIGS. 3 and 4, the source driver chip 12k_1 includes Electro-Static Discharge circuits ESD, driver cells DC, a bias and logic block BLB, input pads IP, and output pads OP. The input pads IP may be connected with input lines IL, and the output pads OP may be connected with output lines OL. The bias and logic block BLB may execute various operations in response to signals input via the input pads IP. The driver cells DC may drive signals that are output to the output pads OP according to control of the bias and logic block BLB. The Electro-Static Discharge circuits ESD may control static electricity transferred via the input and output pads IP and OP.

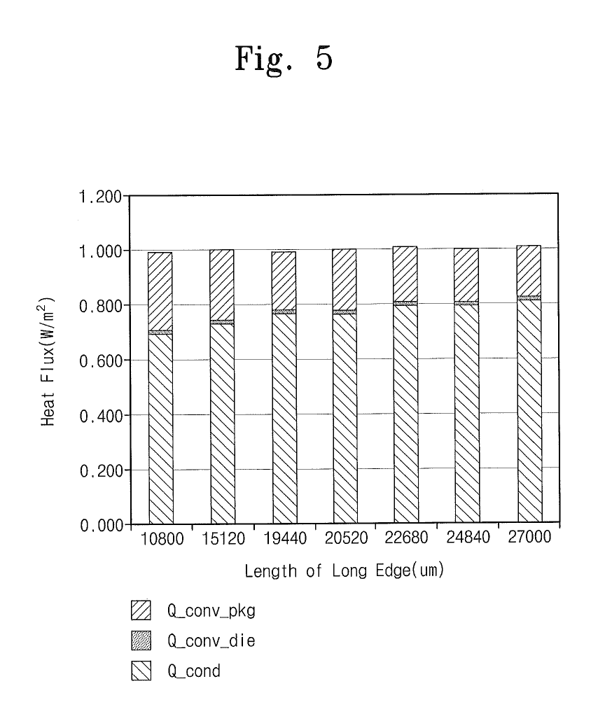

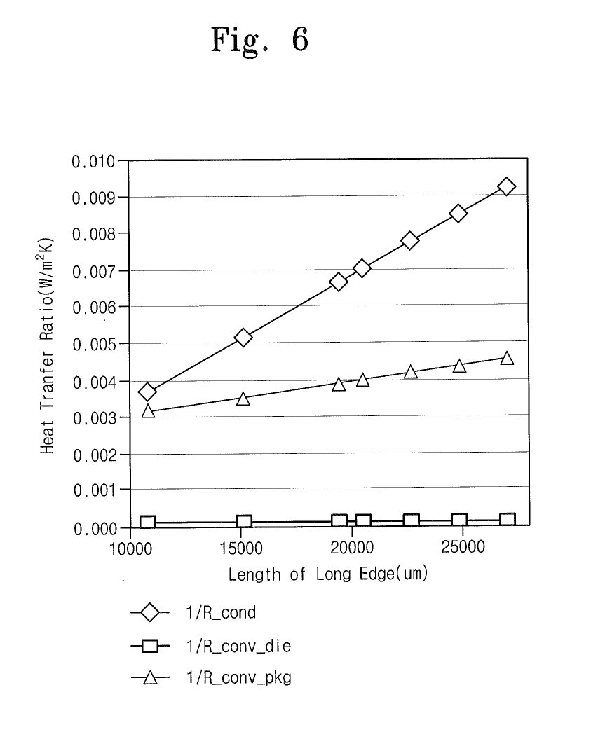

FIGS. 5 and 6 are graphs illustrating a radiation effect. Referring to FIG. 5, a horizontal axis represents a length (in micrometers) of a long (e.g., longest) edge of a source driver chip 12k_1, and a vertical axis represents a radiated heat flux. A first value Q_conv_pkg indicates a heat flux radiated via radiation and convection from a film 150a. A second value Q_conv_die indicates a heat flux radiated via radiation and convection from a source driver chip 12k_1. A third value Q_cond indicates a heat flux radiated via conduction of wires (e.g., input and output lines IL and OL) connected with the source driver chip 12k_1. For example, the third value Q_cond indicates a heat flux corresponding to heat generated by the source driver chip 12k_1 and conducted to a display panel 110 and a PCB 160 so as to be radiated through them. Because the display panel 110 and the PCB 160 are larger in size than the source driver chip 12k_1 and their temperatures are at or near room temperature, heat generated by the source driver chip 12k_1 may be radiated via the display panel 110 and the PCB 160.

As illustrated in FIG. 5, a radiation effect via conduction of wires connected with the source driver chip 12k_1 is greater than that via radiation and convection of the film 150a and the source driver chip 12k_1. The longer a length of a long (e.g., longest) edge of the source driver chip 12k_1, the greater a radiation effect via conduction as compared with that via radiation and convection.

Referring to FIG. 6, a horizontal axis represents a length (in micrometers) of a long (e.g., longest) edge of a source driver chip 12k_1, and a vertical axis represents a heat transfer ratio. A first value 1/R_cond indicates a heat transfer ratio via conduction, a second value 1/R_conv_die indicates a heat transfer ratio via radiation and convection of the source driver chip 12k_1, and a third value 1/R_conv_pkg indicates a heat transfer ratio via radiation and convection of a film 150a. As illustrated in FIG. 6, in the case of conduction (1/R_cond), the slope of the heat transfer ratio according to increasing length of a long (e.g., longest) edge of the source driver chip 12k_1 is steeper (i.e., indicates a higher rate) than that in the case of radiation and convection (1/R_conv_die and 1/R_conv_pkg).

In other words, the longer a length of a long (e.g., longest) edge of the source driver chip 12k_1 and the more wires connected with the source driver chip 12k_1, the greater a radiation effect of a display device 100 may be.

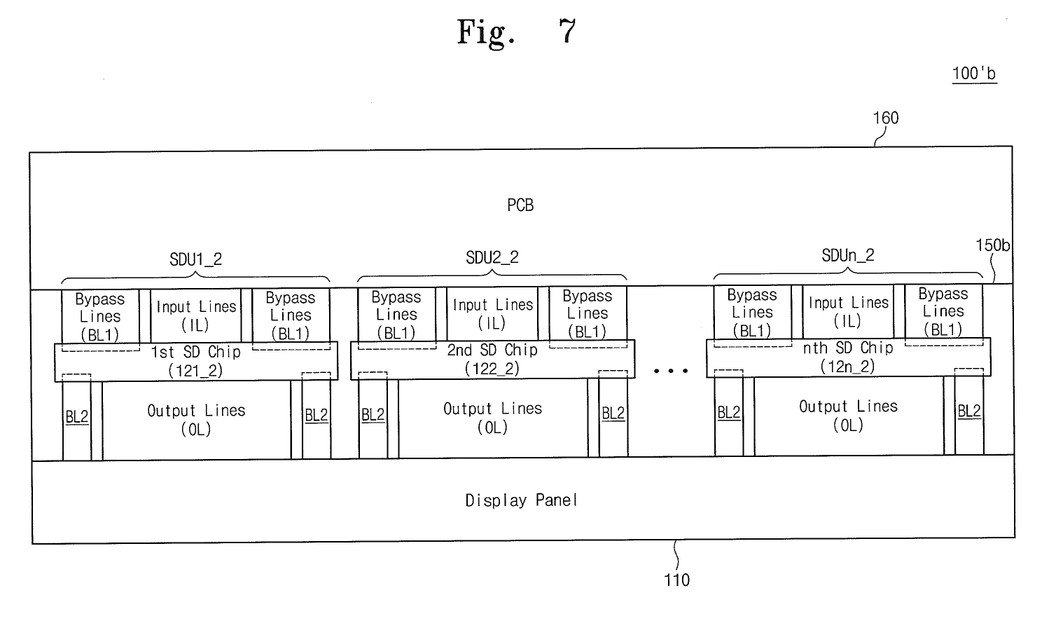

FIG. 7 is a diagram schematically illustrating a film according to various embodiments of the inventive concept. Referring to FIG. 7, a display device 100′b includes a plurality of source driver units SDU1_2 through SDUn_2 provided on a film 150b. Each of the source driver units SDU1_2 through SDUn_2 includes a source driver chip 12k_2 (where k is one of 1 through n), a plurality of input lines IL, a plurality of output lines OL, a plurality of first bypass lines BL1, and a plurality of second bypass lines BL2.

A length of a long (e.g., longest) edge of each of the source driver chips 121_2 through 12n_2 may be longer than that of each of the source driver chips 121_1 through 12n_1 of FIGS. 3 and 4. The source driver chips 121_2 through 12n_2 may extend over/to (e.g., to at least partially overlap) a region where the bypass lines BL1 and BL2 are provided.

The input lines IL are connected with one portion/end (e.g., a top end of a lower surface) of each of the source driver chips 121_2 through 12n_2. The output lines OL are connected with another portion/end (e.g., a bottom end of the lower surface, which is opposite the top end) of each of the source driver chips 121_2 through 12n_2. The input lines IL and the output lines OL may form a straight line (e.g., may be aligned). This enables a heat transfer effect via the input and output lines IL and OL to be improved. However, the inventive concept is not limited thereto. Accordingly, the input lines IL and the output lines OL may be arranged in a variety of other formations, including being arranged to form a curved line.

The first bypass lines BL1 connect a PCB 160 and the source driver chips 121_2 through 12n_2. The second bypass lines BL2 connect a display panel 110 and the source driver chips 121_2 through 12n_2. The first bypass lines BL1 and the second bypass lines BL2 may be interconnected within each of the source driver chips 121_2 through 12n_2. In other words, although the bypass lines BL illustrated in FIG. 3 may directly connect the PCB 160 and the display panel 110, the bypass lines BL1 and BL2 illustrated in FIG. 7 connect the PCB 160 and the display panel 110 through the source driver chips 121_2 through 12n_2.

Moreover, the first bypass lines BL1 may extend substantially in parallel with the input lines IL, and the second bypass lines BL2 may extend substantially in parallel with the output lines OL. Additionally, the source driver chips 121_2 through 12n_2 may extend beyond outer edges of the first and second bypass lines BL1 and BL2 in a direction that is substantially perpendicular to the direction in which the first and second bypass lines BL1 and BL2 and the input lines IL and output lines OL extend substantially in parallel. In other words, the source driver chips 121_2 through 12n_2 may overlap the entire widths (e.g., both inner and outer edges) of the first and second bypass lines BL1 and BL2. The width of each the source driver chips 121_2 through 12n_2 along the perpendicular direction may be greater than the combined widths of either the respective first bypass lines BL1 and the respective input lines IL or the respective second bypass lines BL2 and the respective output lines OL.

If the bypass lines BL1 and BL2 are connected through the source driver chips 121_2 through 12n_2, heat generated by the source driver chips 121_2 through 12n_2 may be conducted via the bypass lines BL1 and BL2. This means that a radiation effect of heat generated by the source driver chips 121_2 through 12n_2 is improved.

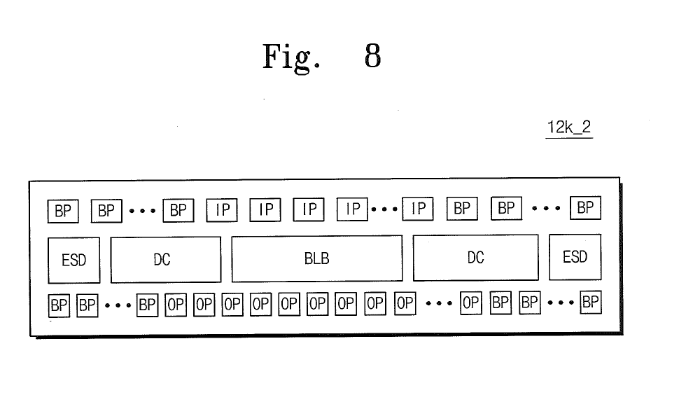

FIG. 8 is a diagram schematically illustrating one of the source driver chips of FIG. 7. Accordingly, one or more of the source driver chips 121_2 through 12n_2 may have the same structure as that illustrated in FIG. 8.

Referring to FIG. 8, a source driver chip 12k_2 includes Electro-Static Discharge circuits ESD, driver cells DC, a bias and logic block BLB, input pads IP, output pads OP, and bypass pads BP. The bypass pads BP may be arranged around corners/edges of the periphery of the source driver chip 12k_2.

The bypass pads BP of the source driver chip 12k_2 may be connected with the bypass lines BL1 and BL2. The number of the output pads OP is more than that of the input pads IP. Moreover, the input pads IP may be larger in size than the output pads OP.

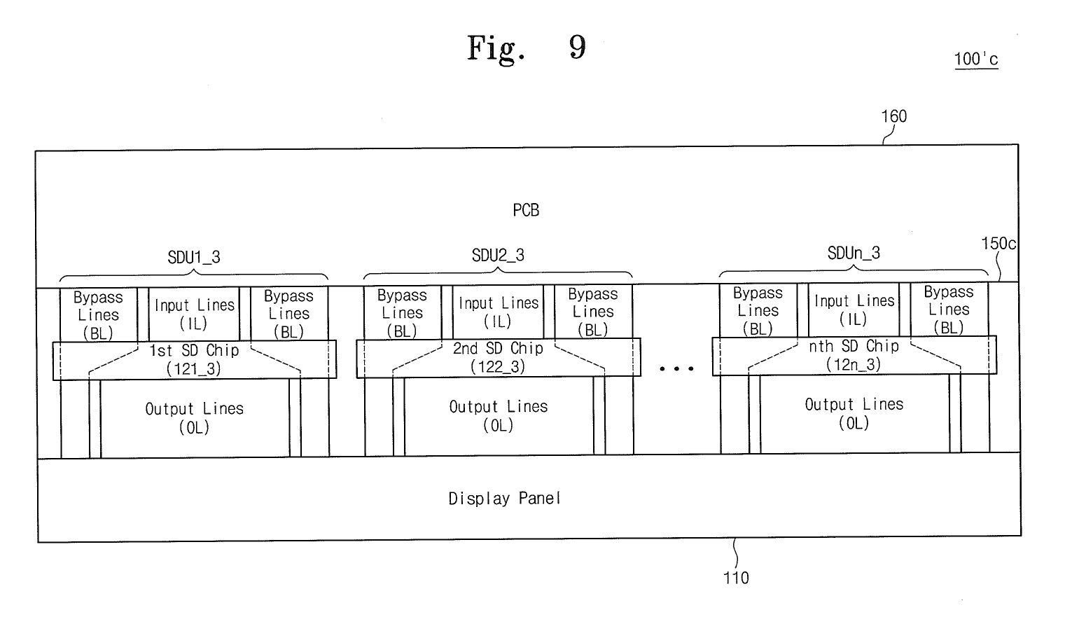

FIG. 9 is a diagram schematically illustrating a film according to various embodiments of the inventive concept. Referring to FIG. 9, a display device 100′c includes a plurality of source driver units SDU1_3 through SDUn_3 provided on a film 150c.

Each of the source driver units SDU1_3 through SDUn_3 includes a source driver chip 12k_3 (k=1 through n), input lines IL, output lines OL, and bypass lines BL. The input lines IL and the output lines OL are connected with the source driver chips 121_3 through 12n_3. The bypass lines BL connect a display panel 110 and a PCB 160. Each of the source driver chips 121_3 through 12n_3 may extend toward a top of a region where the bypass lines BL are provided.

In various embodiments, the bypass lines BL are formed to pass through bottoms of the source driver chips 121_3 through 12n_3 without contacting the source driver chips 121_3 through 12n_3. Heat of the source driver chips 121_3 through 12n_3 may be radiated via the bypass lines BL because the source driver chips 121_3 through 12n_3 are placed close to the bypass lines BL.

The bypass lines BL are formed to pass through bottoms of the source driver chips 121_3 through 12n_3, with the bypass lines BL contacting with the source driver chips 121_3 through 12n_3 via dummy pads. The dummy pads are pads that do not exchange signals with the source driver chips 121_3 through 12n_3. In other words, although the bypass lines BL may be conductive lines that overlap with at least a periphery of the source driver chip 12k_3 to conduct heat therefrom to the PCB 160 and/or the display panel 110, the conductive bypass lines BL may be protected (e.g., electrically separated/isolated) from signal communications with the source driver chip 12k_3. Heat generated by the source driver chips 121_3 through 12n_3 may be radiated via the dummy pads and the bypass lines BL.

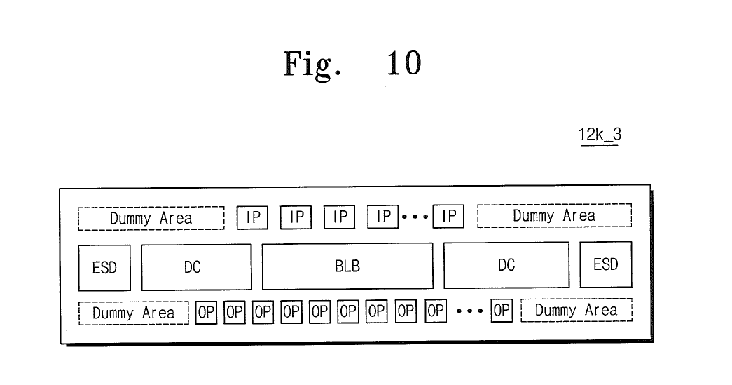

FIG. 10 is a diagram schematically illustrating one of the source driver chips of FIG. 9. Accordingly, one or more of the source driver chips 121_3 through 12n_3 may have the same structure as that illustrated in FIG. 10.

Referring to FIG. 10, a source driver chip 12k_3 (k=1 through n) includes Electro-Static Discharge circuits ESD, driver cells DC, a bias and logic block BLB, input pads IP, and output pads OP. The number of the input pads IP is less than that of the output pads OP. Moreover, the input pads IP are larger in size than the output pads OP.

Dummy areas/regions are provided at a region of a source driver chip 12k3 provided on bypass lines BL. In various embodiments, no pads may be provided on the dummy regions. Alternatively, dummy pads connected with bypass lines BL may be provided at the dummy regions. The dummy pads conduct heat generated by the source driver chip 12k_3 to the bypass lines BL.

According to various embodiments of the inventive concept, a length of a long (e.g., longest) edge of each source driver chip extends to reach a region where bypass lines are formed. In other words, a width of the source driver chip along a direction perpendicular to the bypass lines may overlap a region where the bypass lines are formed. Input and output lines connected with source driver chips may form a straight line (e.g., may be aligned). Heat generated by the source driver chips is conducted via bypass lines. Accordingly, it is possible to provide a display device with an improved radiation function.

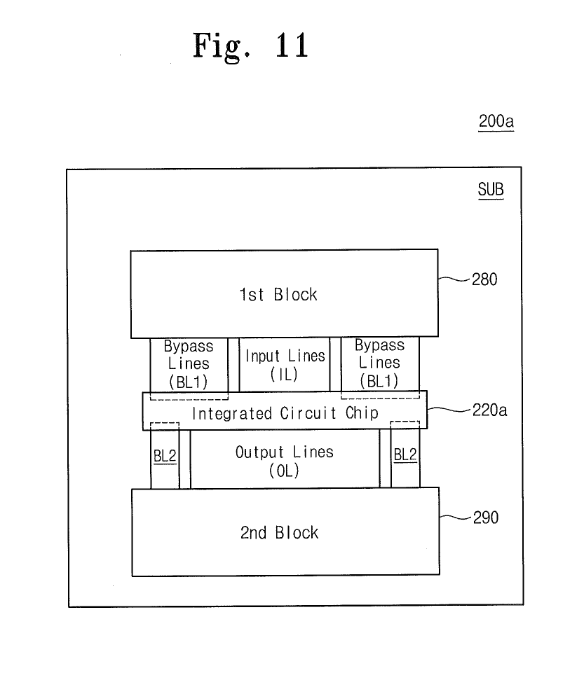

FIG. 11 is a diagram schematically illustrating an integrated circuit device according to various embodiments of the inventive concept. Referring to FIG. 11, an integrated circuit device 200a includes a first block 280, a second block 290, an integrated circuit chip 220a, input lines IL, output lines OL, first bypass lines BL1, and second bypass lines BL2.

The first block 280, the second block 290, the integrated circuit chip 220a, the input lines IL, the output lines OL, the first bypass lines BL1, and the second bypass lines BL2 are provided on a substrate SUB. The substrate SUB may be a film or a semiconductor substrate.

The integrated circuit chip 220a may have the same structure as the source driver chip 12k_2 illustrated in FIG. 8. As described in relation to FIGS. 7 and 8, the input lines IL and the first bypass lines BL1 are connected with one end/portion of a lower surface of the integrated circuit chip 220a. The first bypass lines BL1 extend to a top (e.g., a top surface) of the substrate SUB and to a lower surface/space of the integrated circuit chip 220a. The output lines OL and the second bypass lines BL2 are connected with the other/opposite end/portion of the lower surface of the integrated circuit chip 220a. The second bypass lines BL2 extend along a top (e.g., a top surface) of the substrate SUB and along a lower surface/space of the integrated circuit chip 220a. In other words, the integrated circuit chip 220a may extend onto a top (e.g., a top surface) of the first and second bypass lines BL1 and BL2. Heat generated by the integrated circuit chip 220a is radiated to the first and second blocks 280 and 290 via the first and second bypass lines BL1 and BL2.

At least one of the first and second blocks 280 and 290 may be a block, such as a PCB, a display panel, etc., maintaining approximately a room temperature. The first and second blocks 280 and 290 may be a block with a radiation function such as a cooler. The first and second blocks 280 and 290 may radiate heat transferred from the integrated circuit chip 220a.

In various embodiments, the first bypass lines BL1 and the input lines IL are connected with the first block 280. Alternatively, the first bypass lines BL1 and the input lines IL may be connected with different blocks from each other (e.g., including different sub blocks of the first block 280). Likewise, the second bypass lines BL2 and the output lines OL may be connected with different blocks from each other (e.g., including different sub blocks of the second block 290).

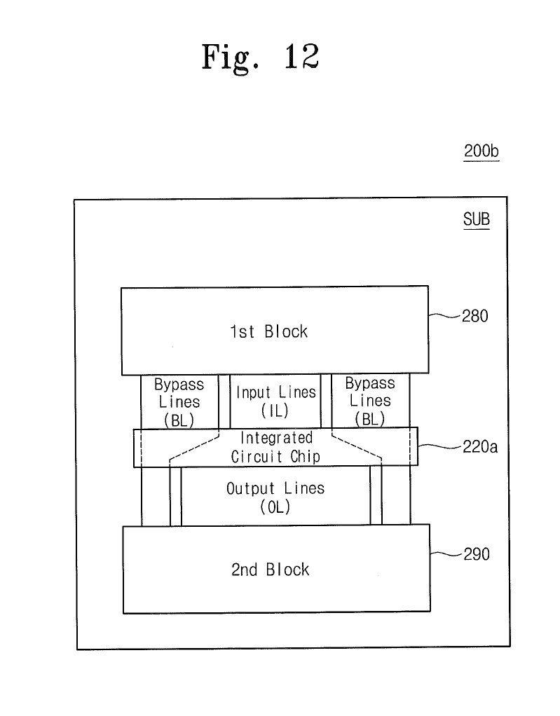

FIG. 12 is a diagram schematically illustrating an integrated circuit device according to various embodiments of the inventive concept. Referring to FIG. 12, an integrated circuit device 200b includes a first block 280, a second block 290, an integrated circuit chip 220b, input lines IL, output lines OL, and bypass lines BL.

The integrated circuit chip 220b may have the same structure as that illustrated for the source driver chip 12k_3 in FIG. 10. As described in relation to FIGS. 9 and 10, the input lines IL are connected with one end/portion of a lower surface of the integrated circuit chip 220b. The output lines OL are connected with the opposite/other end/portion of the lower surface of the integrated circuit chip 220b. The bypass lines BL may directly connect the first and second blocks 280 and 290 on a substrate SUB. The bypass lines BL may be provided at a top (e.g., a top surface) of the substrate SUB and at a bottom (e.g., a bottom surface) of the integrated circuit chip 220b. In other words, the integrated circuit chip 220b may extend over/to a top of the bypass lines BL. As such, the bypass lines BL may be between the top surface of the substrate SUB and the bottom surface of the integrated circuit chip 220b. Heat generated by the integrated circuit chip 220b is radiated to the first and second blocks 280 and 290 via the bypass lines BL.

At least one of the first and second blocks 280 and 290 may be a block, such as a PCB, a display panel, etc., that is configured to maintain approximately a room temperature. For example, at least one of the first and second blocks 280 and 290 may be a block with a radiation function such as a cooler. The first and second blocks 280 and 290 may radiate heat transferred from the integrated circuit chip 220b.

In various embodiments, the bypass lines BL and the input lines IL may be connected with the first block 280. Alternatively, the bypass lines BL and the input lines IL may be connected with different blocks from each other (e.g., including different sub blocks of the first block 280). Likewise, the bypass lines BL and the output lines OL may be connected with different blocks from each other (e.g., including different sub blocks of the second block 290).

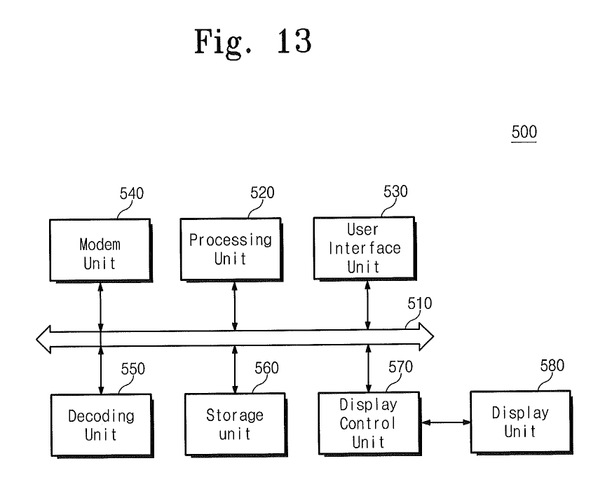

FIG. 13 is a block diagram schematically illustrating a multimedia device (e.g., a portable electronic device and/or a television) according to various embodiments of the inventive concept. Referring to FIG. 13, a multimedia device 500 includes a bus 510, a processing unit 520, a user interface unit 530, a modem unit 540, a decoding unit 550, a storage unit 560, a display control unit 570, and a display unit 580.

The bus 510 provides a channel among (e.g., that connects with) constituent elements of the multimedia device 500. The processing unit 520 controls an overall operation of the multimedia device 500.

The user interface unit 530 exchanges information with a user. The user interface unit 530 may include user input interfaces (e.g., for receiving information), such as a keyboard, a mouse, a button, a touch pad, a touch panel, a track ball, a camera, a microphone, a sensor, etc. The user interface unit 530 may also include user output interfaces (e.g., for outputting information), such as a lamp, a speaker, a printer, a monitor, etc.

The modem unit 540 communicates with an external device in a wireless or wired manner. The modem unit 540 modulates a signal that is output to an external device and demodulates a signal that is input from the external device.

The decoding unit 550 decodes signals. For example, the decoding unit 550 decodes signals modulated by the modem 540. The decoding unit 550 outputs the decoded signals to the user interface unit 530 or the display control unit 570, or stores the decoded signals in the storage unit 560. The decoding unit 550 may further provide encoding functions. For example, the decoding unit 550 may encode signals acquired by the user interface unit 530. The encoded signals may be output to the external device via the modem unit 540 or stored in the storage unit 560.

The storage unit 560 is a working memory of the processing unit 520. The storage unit 560 may be used as a buffer memory, a cache memory, a mass storage device, etc.

The display control unit 570 controls the display unit 580 to display signals decoded by the decoding unit 550 or signals acquired by a camera of the user interface unit 530.

The display unit 580 displays an image according to control of the display control unit 570. The display unit 580 may be a display unit (e.g., the display device 100) described in relation to FIG. 1. Moreover, as described herein, the display unit 580 may include a PCB, a film, and a display panel. Each of source driver chips of the film may extend over/to a top of bypass lines. Accordingly, heat generated by the source driver chips is radiated via the bypass lines.

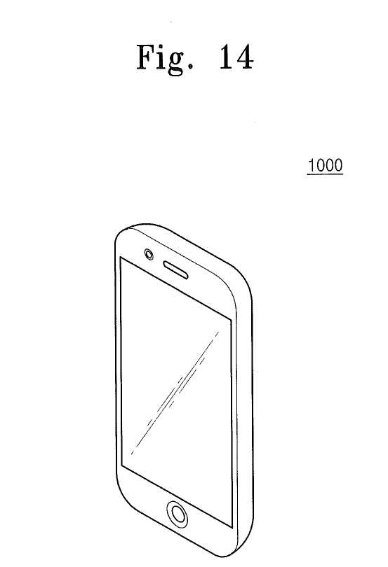

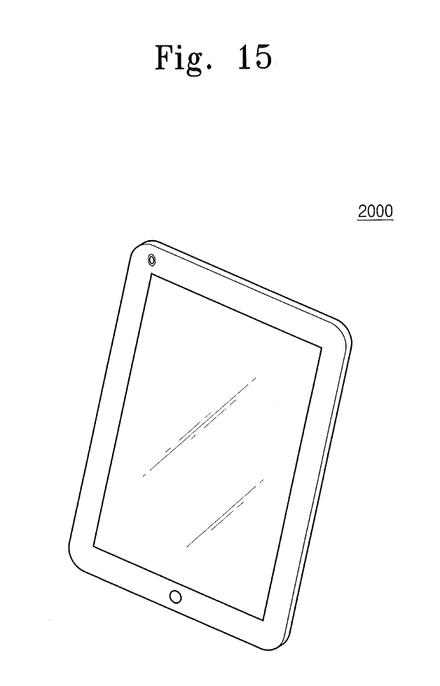

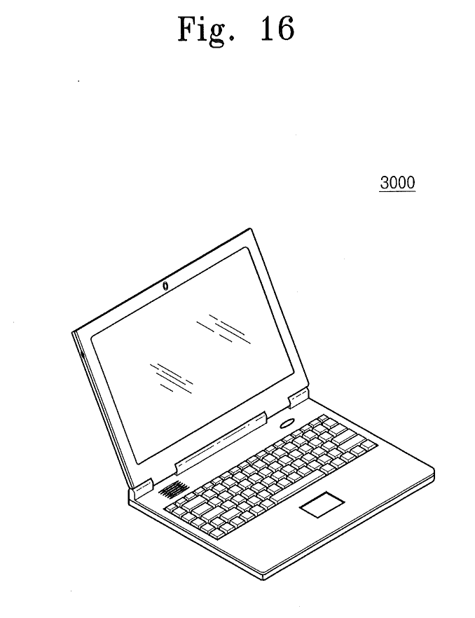

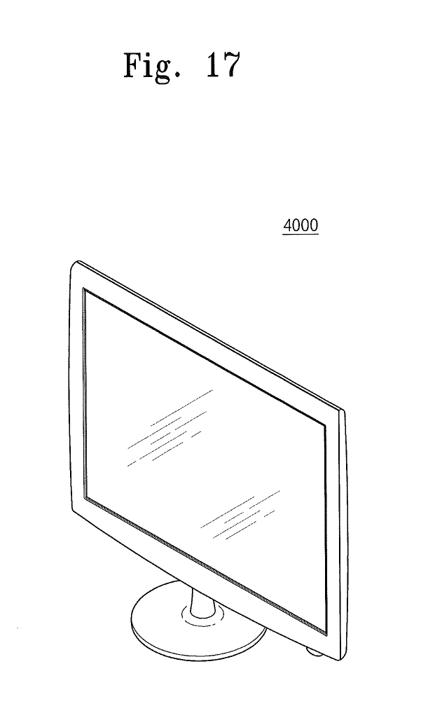

FIGS. 14 to 17 are diagrams illustrating examples of a multimedia device according to various embodiments of the inventive concept. The architecture of source driver chips and bypass lines according to various embodiments of the inventive concept is applicable to various multimedia devices having an image display function. For example, the architecture of source driver chips and bypass lines according to various embodiments of the inventive concept is applicable to a mobile phone or a smart phone 1000 as illustrated in FIG. 14, to a tablet or a smart tablet 2000 as illustrated in FIG. 15, to a notebook/netbook computer 3000 as illustrated in FIG. 16, and to a television/monitor or a smart television/monitor 4000 as illustrated in FIG. 17.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A display device comprising:
a printed circuit board;
a display panel; and
a film connected between the printed circuit board and the display panel, the film including a plurality of source driver units thereon, each of the plurality of source driver units comprising:
a source driver chip;
a plurality of input lines connected between the source driver chip and the printed circuit board;
a plurality of output lines connected between the source driver chip and the display panel; and
a plurality of bypass lines electrically connected between the printed circuit board and the display panel, the source driver chip overlapping at least a portion of the plurality of bypass lines.

2. The display device of claim 1, wherein the plurality of bypass lines are protected from signal communications with the source driver chip, and are configured to radiate heat from the source driver chip to the printed circuit board and the display panel.

3. The display device of claim 1, wherein the plurality of input lines are connected between the printed circuit board and input pads that are on a first end of a lower surface of the source driver chip, and wherein the plurality of output lines are connected between the display panel and output pads that are on a second end of the lower surface of the source driver chip.

4. The display device of claim 1, wherein the bypass lines comprise:
a plurality of first bypass lines connected between the source driver chip and the printed circuit board; and
a plurality of second bypass lines connected between the source driver chip and the display panel,
wherein the source driver chip electrically connects the plurality of first bypass lines and the plurality of second bypass lines.

5. The display device of claim 4, wherein the plurality of first bypass lines are connected between the printed circuit board and bypass pads that are on a first end of a lower surface of the source driver chip.

6. The display device of claim 4, wherein the plurality of second bypass lines are connected between the display panel and bypass pads that are on a second end of a lower surface of the source driver chip.

7. The display device of claim 1, wherein some of the bypass lines connect with gates of pixels of the display panel.

8. The display device of claim 1, wherein a plurality of pads are on first and second opposing ends of a lower surface of the source driver chip, and wherein the pads on the first end are larger in size than the pads on the second end.

9. The display device of claim 1, wherein a plurality of pads are on first and second opposing ends of a lower surface of the source driver chip, and wherein the pads on the second end are more numerous than the pads on the first end.

10. The display device of claim 1, wherein the plurality of bypass lines directly connect the printed circuit board and the display panel.

11. The display device of claim 10, wherein a plurality of pads are on first and second opposing ends of a lower surface of the source driver chip, and wherein the lower surface of the source driver chip further comprises pad-less dummy regions on the plurality of bypass lines.

12. The display device of claim 1, wherein the plurality of input lines and the plurality of output lines form a straight line.

13. A multimedia device comprising:
a modem unit;
a decoding unit configured to decode data input via the modem unit;
a display unit;
a display control unit configured to control the display unit to display decoded data from the decoding unit; and
a processing unit that is configured to control the modem unit, the decoding unit, the display unit, the display control unit, and a user interface unit,
wherein the display unit comprises a display device that includes a film connected between a printed circuit board and a display panel,
wherein a plurality of source driver units are on the film, and
wherein each of the plurality of source driver units comprises:
a source driver chip;
a plurality of input lines connected between the source driver chip and the printed circuit board;
a plurality of output lines connected between the source driver chip and the display panel; and
a plurality of bypass lines electrically connected between the printed circuit board and the display panel, the source driver chip overlapping at least a portion of the bypass lines.

14. The multimedia device of claim 13, wherein the modem unit, the decoding unit, the display unit, the display control unit, the user interface unit, and the processing unit are included in a television, and wherein the plurality of bypass lines are protected from signal communications with the source driver chip, and are configured to radiate heat from the source driver chip to the printed circuit board and the display panel.

15. A display device comprising:
a printed circuit board;
a display panel;
a source driver chip between the printed circuit board and the display panel; and
a plurality of conductive bypass lines extending between the printed circuit board and the display panel, wherein the plurality of conductive bypass lines overlap with at least a periphery of the source driver chip to conduct heat therefrom to the printed circuit board and/or the display panel.

16. The display device of claim 15, further comprising:
a plurality of input lines connected between the source driver chip and the printed circuit board; and
a plurality of output lines connected between the source driver chip and the display panel,
wherein the plurality of conductive bypass lines extend in a direction substantially in parallel with at least one of the plurality of input lines and the plurality of output lines, and
wherein the plurality of conductive bypass lines are protected from signal communications with the source driver chip.

17. The display device of claim 16, wherein the source driver chip extends in a direction substantially perpendicular to the direction in which the plurality of conductive bypass lines extend, to overlap entire widths of the plurality of conductive bypass lines.

18. The display device of claim 17, wherein a width of the source driver chip along the perpendicular direction is greater than combined widths of the plurality of conductive bypass lines and either the plurality of input lines or the plurality of output lines along the perpendicular direction.

19. The display device of claim 15, wherein the plurality of conductive bypass lines contact the source driver chip via dummy pads.

20. The display device of claim 15, wherein the plurality of conductive bypass lines comprise:
a plurality of first conductive bypass lines connected to a first end of the source driver chip; and
a plurality of second conductive bypass lines connected to a second end of the source driver chip that is opposite the first end, such that the first and second conductive bypass lines connect the printed circuit board and the display panel through the source driver chip.
